(19) United States
(12) Patent Application Publication
(10) Pub. No.: US 2026/0134539 A1
(43) Pub. Date: May 14, 2026

(54) DEVICE AND METHOD FOR EYE DIAGRAM GENERATION

(71) Applicant: HUAWEI TECHNOLOGIES CO., LTD., Shenzhen (CN)

(72) Inventors: Tom Jonas Wettlin, Munich (DE); Nebojsa Stojanovic, Munich (DE)

(73) Assignee: HUAWEI TECHNOLOGIES CO., LTD., Shenzhen (CN)

(21) Appl. No.: 19/442,674

(22) Filed: Jan. 7, 2026

Related U.S. Application Data
(63) Continuation of application No. PCT/EP2023/079998, filed on Oct. 26, 2023.

(51) Int. Cl. G06T 7/00; G06T 5/40

(52) U.S. Cl. CPC G06T 7/0012; G06T 5/40; G06T 2207/30041

(57) ABSTRACT

An apparatus, a receiver device, and a method for generating an eye diagram of a digital signal at a receiver device are provided. The apparatus is configured to obtain the digital signal, wherein the digital signal is based on a transmitting signal sent by a transmitter device over a channel to the receiver device. The apparatus is further configured to sample the obtained digital signal to obtain a set of sampled digital signals and process each sampled digital signal of the set of sampled digital signals, based on a soft-output MLSE algorithm and one or more DSP parameters, to obtain a set of processed sampled digital signals. The apparatus is further configured to reconstruct a signal histogram for each processed sampled digital signal to obtain a set of reconstructed signal histograms and generate an eye diagram based on the set of reconstructed signal histograms.

### CROSS-REFERENCE TO RELATED APPLICATIONS

This application is a continuation of International Application No. PCT/EP2023/079998, filed on Oct. 26, 2023, the disclosure of which is hereby incorporated by reference in its entirety.

### FIELD

The present disclosure relates to communication networks, particularly to transmission quality assessment in communication networks. The disclosure proposes an apparatus, a receiver device, and a method for generating an eye diagram of a digital signal at the receiver device.

### BACKGROUND

In communication systems, the signal is impaired by various effects, such as noise, bandwidth limitations, and nonlinearities. Since it is often not possible to determine the impact of all these effects on the quality of the received signal in advance, a quick way to visualize the signal quality is required. A common and frequently applied way to do this is called an eye diagram. This visualization technique gives insight into the probability of different signal levels across the unit interval.

Different lab devices like oscilloscopes have the option of showing the eye diagram of the received signal so that the user can estimate the transmission quality without processing the data. This helps to save time and effort, especially during the optimization of a system.

The eye diagram can be shown after digital signal processing (DSP) schemes to quickly assess the performance.

For different applications, like optical communication systems, maximum likelihood sequence estimation (MLSE) becomes an attractive DSP solution due to its good performance. However, because this structure only outputs hard decisions or symbol/bit log-likelihood ratios (LLRs), if a soft-output implementation is used, nowadays only limited options to visualize the eye diagram after MLSE exist.

Therefore, a non-data-aided solution to generate an eye diagram after MLSE, which gives correct insights about the performance in a certain sampling phase range, is of interest.

### SUMMARY

In view of the above-mentioned limitations, the present disclosure aims to provide a reliable, high precision, and non-data-aided solution to generate eye diagrams after MLSE. The present disclosure provides for visualization of eye diagrams after soft-output MLSE thereby providing quick information about the transmission quality. Further implementations may allow more efficient prototyping and debugging in experimental setups.

A first aspect of this disclosure provides an apparatus for generating an eye diagram of a digital signal at a receiver device. The apparatus is configured to obtain the digital signal, wherein the digital signal is based on a transmitting signal sent by a transmitter device over a channel to the receiver device. The apparatus is further configured to sample the obtained digital signal to obtain a set of sampled digital signals; and process each sampled digital signal of the set of sampled digital signals based on a soft-output MLSE algorithm, and one or more DSP parameters, to obtain a set of processed sampled digital signals. Then, the apparatus is configured to reconstruct a signal histogram for each processed sampled digital signal to obtain a set of reconstructed signal histograms; and generate an eye diagram based on the set of reconstructed signal histograms.

This disclosure thus proposes a solution to generate an eye diagram after soft-output MLSE. The transmission signal may, for example, be a Pulse Amplitude Modulation 4-level (PAM-4) signal. The channel may be a fiber. The approach proposed in this disclosure is based on reconstructed signal histograms after an exemplary designed sampling and processing procedure. Notably, the “soft-output” here refers to “soft” information such as information about the reliability of a decision is generated, in contrast to a hard decision.

In an implementation form of the first aspect, so as to process each sampled digital signal, the apparatus is further configured to equalize the sampled digital signal using a feed forward equalizer (FFE); filter the equalized signal output by the FFE using a whitening filter; and apply the soft-output MLSE algorithm on the filtered signal output by the whitening filter, to obtain a processed sampled digital signal, wherein the processed sampled digital signal comprises a set of symbol-wise LLRs.

While the signal distribution is available without further steps after DSP steps e.g., FFE and decision-feedback equalization (DFE), a novel reconstruction technique based on the symbol-wise LLRs is used to obtain similar distributions after MLSE.

In an implementation form of the first aspect, the apparatus is further configured to determine an optimal sampling phase for sampling the obtained digital signal.

For the initialization, timing recovery is first performed. The timing recovery finds the optimal sampling phase.

In an implementation form of the first aspect, the apparatus is further configured to: sample the obtained digital signal at the optimal sampling phase to obtain an optimal sampled digital signal; determine a sampling phase shift; and obtain the set of sampled digital signals based on the optimal sampled digital signal and the sampling phase shift using digital interpolation.

For the eye diagram generation, the sampling phase of the “ideally” sampled signal, e.g., the optimal sampled digital signal, is shifted in a pre-defined range of sampling phases with a defined resolution. The sampling phase shift can be realized by digital interpolation, for instance, if the signal at the input of the receiver DSP is available with sufficient oversampling.

In an implementation form of the first aspect, the apparatus is further configured to: phase shift the optimal sampling phase in a pre-defined range to obtain a set of sampling phases; and sample the obtained digital signal at each sampling phase of the set of sampling phases to obtain the set of sampled digital signals.

As an alternative, an analog phase interpolator can be used to realize the desired sampling phase sweep.

In an implementation form of the first aspect, the apparatus is further configured to: obtain the one or more DSP parameters at the optimal sampling phase, wherein the DSP parameters comprise one or more of the following: an equalizing coefficient, a filtering coefficient, an MLSE transition metric, a threshold, and a normalization factor. Optionally, all DSP parameters are to be converged at the optimal sampling phase.

In an implementation form of the first aspect, the apparatus is further configured to: equalize the sampled digital signal using the FFE based on one or more equalizing coefficients; filter the equalized signal using the whitening filter based on one or more filtering coefficients; and apply the MLSE algorithm on the filtered signal based on one or more MLSE transition metrics.

For each sampling phase under test, FFE, noise whitening filter, and the MLSE algorithm are applied with the stored DSP parameters. The resulting LLRs are used for the signal reconstruction and the reconstructed signal histogram is stored for each case.

In an implementation form of the first aspect, the apparatus is further configured to apply the MLSE algorithm on the filtered signal to obtain the set of LLRs using one of the following detectors:
a soft-output Viterbi (SOVA) detector,
a Bahl, Cocke, Jelinek and Raviv, BCJR, detector, and
a maximum a posteriori probability (MAP) detector.

In order to reconstruct the signal histogram after soft-output MLSE, one requirement is a detector that outputs symbol-wise LLRs. This means, that for each transmitted symbol, a number of LLRs according to the number of elements in the symbol alphabet is generated. Popular schemes to generate the soft-output information include Viterbi algorithms with soft-decision outputs, a BCJR detector, or any (other) realization of a MAP detector.

In an implementation form of the first aspect, the apparatus is further configured to determine a symbol level corresponding to each LLR.

In an implementation form of the first aspect, the apparatus is further configured to reconstruct the signal histogram for each processed sampled digital signal based on the set of LLRs and the symbol levels corresponding to the set of LLRs.

Notably, the value of the LLR corresponding to a certain symbol level is directly related to the probability, that this symbol level is the transmitted symbol. The signal histogram can be constructed based on the symbol levels and the values of LLRs.

In an implementation form of the first aspect, the apparatus is further configured to obtain the normalization factor by analyzing the set of reconstructed signal histograms and the symbol levels corresponding to the set of LLRs.

For instance, the normalization factor can be found by finding the peaks in the histogram parts and finding the ratio between the distances of these peaks and the distance between the levels in the symbol alphabet.

In an implementation form of the first aspect, the apparatus is further configured to obtain the threshold by analyzing a histogram obtained after equalizing the obtained digital signal using FFE. In a linear transmission, the threshold can be chosen as the center between a pair of neighboring levels. If nonlinear effects distort the levels during transmission, the threshold can be obtained by analyzing the histogram after FFE.

In an implementation form of the first aspect, the apparatus is further configured to generate the eye diagram by combining the set of reconstructed signal histograms based on the threshold and the normalization factor. When all parts of signal histograms are obtained, they can be combined using heuristically calculated normalization factors and thresholds.

In an implementation form of the first aspect, the transmitting signal sent by the transmitter device is an optical signal.

A second aspect of this disclosure provides a receiver device comprising the apparatus of the first aspect or any of its implementation forms, wherein the receiver device is configured to receive a signal sent by a transmitter device over a channel; and convert the signal into the digital signal.

The signal sent by the transmitter device is an optical signal, for example, a PAM signal. The receiver device 10 may comprise a photodetector to convert the optical signal into the electrical signal, e.g., the digital signal 101.

Implementation forms of the receiver device of the second aspect may correspond to the implementation forms of the apparatus of the first aspect described above. The receiver device of the second aspect and its implementation forms achieve the same advantages and effects as described above for the apparatus of the first aspect and its implementation forms.

A third aspect of this disclosure provides a method for generating an eye diagram of a digital signal at a receiver device, the method comprising: obtaining the digital signal, wherein the digital signal is based on a transmitting signal sent by a transmitter device over a channel to the receiver device; sampling the obtained digital signal to obtain a set of sampled digital signals; processing each sampled digital signal of the set of sampled digital signals based on a soft-output MLSE algorithm, and one or more DSP parameters, to obtain a set of processed sampled digital signals; reconstructing a signal histogram for each processed sampled digital signal, to obtain a set of reconstructed signal histograms; and generating an eye diagram based on the set of reconstructed signal histograms.

Implementation forms of the method of the third aspect may correspond to the implementation forms of the apparatus of the first aspect described above. The method of the third aspect and its implementation forms achieve the same advantages and effects as described above for the apparatus of the first aspect and its implementation forms.

A fourth aspect of this disclosure provides a non-transitory storage medium storing executable program code which, when executed by a processor, causes the method according to the third aspect or any of its implementation forms to be performed.

It has to be noted that all devices, elements, units, and means described in the present application could be implemented in the software or hardware elements or any kind of combination thereof. All steps that are performed by the various entities described in the present application as well as the functionalities described to be performed by the various entities are intended to mean that the respective apparatus is adapted to or configured to perform the respective steps and functionalities. Even if, in the following description of exemplary embodiments, a specific functionality or step to be performed by external entities is not reflected in the description of a specific detailed element of that apparatus that performs that specific step or functionality, it should be clear for a skilled person that these methods and functionalities can be implemented in respective software or hardware elements or any kind of combination thereof.

### DESCRIPTION OF DRAWINGS

The above-described aspects and implementation forms will be explained in the following description of exemplary embodiments in relation to the enclosed drawings, in which

FIG. 1 shows an apparatus according to an embodiment of the disclosure.

FIG. 2 shows an exemplary visualization of the steps for signal reconstruction according to an embodiment of the disclosure.

FIG. 3 shows a structure of an optical communication system according to an embodiment of the disclosure.

FIG. 4 shows an exemplary procedure for the generation of an eye diagram according to an embodiment of disclosure.

FIG. 5 shows an exemplary eye diagram obtained according to an embodiment of the disclosure.

FIG. 6 shows a receiver device according to an embodiment of the disclosure.

FIG. 7 shows a method for generating an eye diagram according to an embodiment of the disclosure.

### DETAILED DESCRIPTION OF EMBODIMENTS

Illustrative embodiments of an apparatus, a receiver device, and a corresponding method for generating an eye diagram of a digital signal at a receiver device are described with reference to the figures. Although this description provides a detailed example of possible implementations, it should be noted that the details are intended to be exemplary and in no way limit the scope of the application.

Moreover, an embodiment/example may refer to other embodiments/examples. For example, any description including but not limited to terminology, element, process, explanation, and/or technical advantage mentioned in one embodiment/example is applicable to the other embodiments/examples. The same elements are labeled with the same reference signs and may function similarly or likewise.

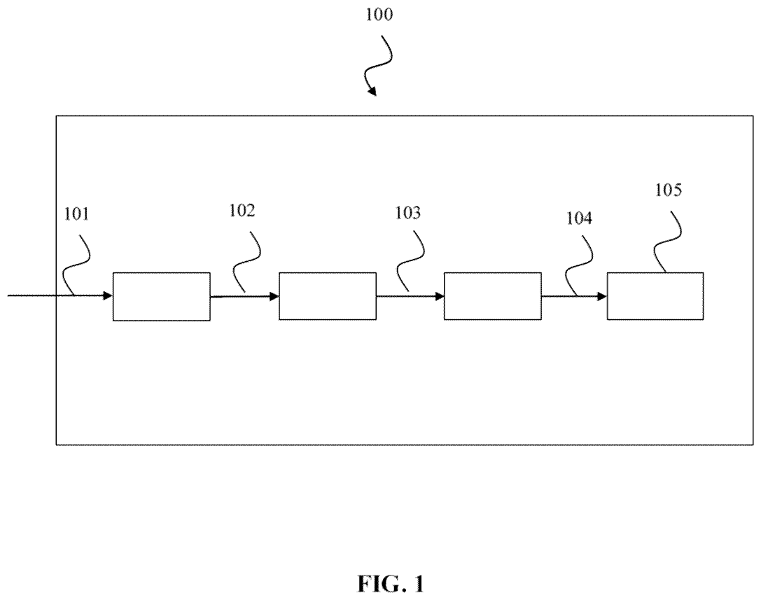

FIG. 1 shows an apparatus 100 according to this disclosure. The apparatus 100 is proposed for generating an eye diagram of a digital signal 101 at a receiver device. The apparatus 100 is configured to obtain the digital signal 101, wherein the digital signal 101 is based on a transmitting signal sent by a transmitter device over a channel to the receiver device. The transmitting signal may be an optical signal, and the channel may be a fiber. The receiver device of this disclosure may receive the optical signal and convert the optical signal into the digital signal 101.

Notably, the present disclosure can be applied to any system and scenario, in which a soft-output MLSE detector is used in the receiver DSP. Optionally, the digital signal 101 is based on a PAM signal (e.g., PAM-4 signal) sent by the transmitter device. The digital signal 101 may be an electrical signal, whereas the PAM signal may be an optical signal.

The apparatus 100 is further configured to sample the obtained digital signal 101 to obtain a set of sampled digital signals 102. After obtaining the set of sampled digital signals 102, the apparatus 100 is configured to process each sampled digital signal 102 of the set of sampled digital signals based on a soft-output MLSE algorithm, and one or more DSP parameters, to obtain a set of processed sampled digital signals. Then, the apparatus is further configured to reconstruct a signal histogram 104 for each processed sampled digital signal 103 to obtain a set of reconstructed signal histograms 104, and generate an eye diagram 105 based on the set of reconstructed signal histograms 104.

The disclosure proposes an approach to generate eye diagrams after soft-output MLSE detectors based on reconstructed signal histograms. While the signal distribution is available without further steps after DSP steps like FFE and DFE, a novel reconstruction technique based on the soft-output information (e.g., symbol-wise LLRs) is used to obtain similar distributions after MLSE. To generate the eye diagram, the sampling phase of the received signal may be successively shifted in the range of interest and for each sampling phase, the DSP stack including MLSE is processed. The signal distribution for each sampling phase is reconstructed and saved, and finally, the eye diagram is assembled from these signals.

There are two main points of the present disclosure.

First, this disclosure provides an approach for reconstructing the signal histogram after soft-output MLSE. One requirement for this is a detector that outputs symbol-wise LLRs. This means, that for each transmitted symbol, a number of LLRs according to the number of elements in the symbol alphabet A={a₀, a₂, . . . , a_{N-1}} is generated. The value of the LLR LLRᵢ corresponding to a certain symbol level aᵢ is directly related to the probability, that this symbol level is the transmitted symbol.

According to an embodiment of this disclosure, the apparatus 100 is configured to determine a symbol level corresponding to each LLR.

For each pair of neighboring levels aᵢ, aⱼ, ∈ A, the positions pᵢⱼ can be found, for which one of the levels has the highest LLR of all levels and the other level has the second highest LLR. Afterward, parts of the histogram can be constructed as:

$${h}_{ij} = - {LLR}_{j} ( {p}_{ij} ) + {LLR}_{i} ( {p}_{ij} ) . \qquad ( 1 )$$

Optionally, the apparatus 100 is further configured to reconstruct the signal histogram 104 for each processed sampled digital signal 103 based on the set of LLRs and the symbol levels corresponding to the set of LLRs.

Once all parts are obtained, they can be combined using heuristically calculated normalization factors nᵢⱼ and thresholds tᵢⱼ as:

$${h}_{comb} ( {p}_{ij} ) = {h}_{ij} \cdot {n}_{ij} + {t}_{ij} . \qquad ( 2 )$$

Optionally, the apparatus 100 is further configured to generate the eye diagram 105 by combining the set of reconstructed signal histograms 104 based on the threshold and the normalization factor.

According to an embodiment of this disclosure, the apparatus 100 is configured to obtain the threshold by analyzing a histogram obtained after equalizing the obtained digital signal using FFE.

Notably, in a linear transmission, the thresholds tᵢⱼ can be chosen as the centers between the levels aᵢ and aⱼ. If nonlinear effects distort the levels during transmission, the thresholds can be obtained by analyzing the histogram after FFE. The normalization factors can be found in a similar way by finding the peaks in the histogram parts hᵢⱼ and finding the ratio between the distances of these peaks and the distance between the levels in the symbol alphabet.

According to an embodiment of this disclosure, the apparatus 100 is configured to obtain the normalization factor by analyzing the set of reconstructed signal histograms 104 and the symbol levels corresponding to the set of LLRs.

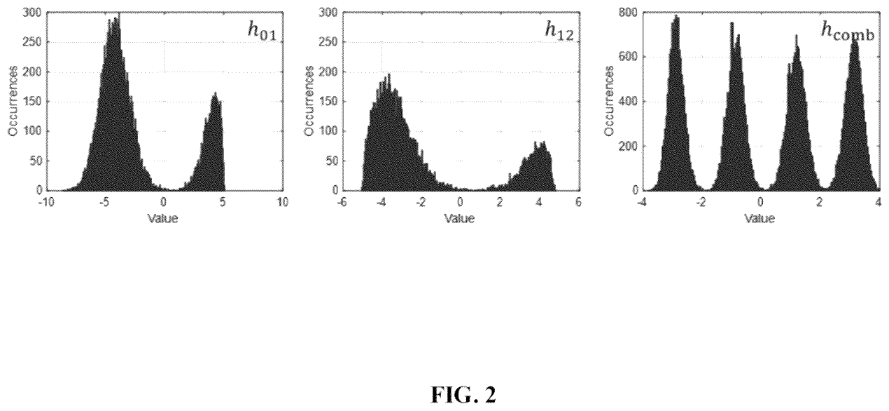

An example of the signal reconstruction of a 112 GBd PAM-4 signal is shown in FIG. 2. In this embodiment, the signal is based on the symbol alphabet A={−3, −1, 1, 3}, and the corresponding LLRs per level were obtained by BCJR detection. To generate the histogram part h₀₁, those positions in the LLR matrix have to be found, where the LLR value corresponding to the level −3 has the highest value and −1 has the second highest value, or vice versa. Once the position vector p₀₁ is found, the histogram part is generated using Equation (1). In the same manner, h₁₂ and h₂₃ can be generated. The combined signal is reconstructed using the histogram parts and Equation (2), where the normalization factors scale the signal parts according to the target levels and the thresholds shift the parts to their correct positions.

Second, this disclosure further proposes a strategy to obtain the correct histograms for different sampling phases and constructing the eye diagram. As a first step, all DSP parameters need to be converged at the optimal sampling phase. This may include FFE coefficients, noise whitening filter coefficients, MLSE transition metrics, decision thresholds, and normalization factors for the histogram parts. Next, for all sampling phase points, the signal's sampling phase is shifted and the signal is processed with the DSP steps using the stored parameters. After soft-output MLSE, the signal histogram reconstruction is done, where the positions pᵢⱼ are found based on the LLRs for the respective sampling phase. For the combination of the histogram parts, the normalization factors and thresholds obtained at the optimal sampling phase are used.

According to an embodiment of this disclosure, so as to process each sampled digital signal 102, the apparatus 100 is configured to equalize the sampled digital signal 102 using a FFE; filter the equalized signal output by the FFE using a whitening filter; and apply the soft-output MLSE algorithm on the filtered signal output by the whitening filter, to obtain a processed sampled digital signal 103. In particular, the processed sampled digital signal 103 comprises a set of symbol-wise LLRs.

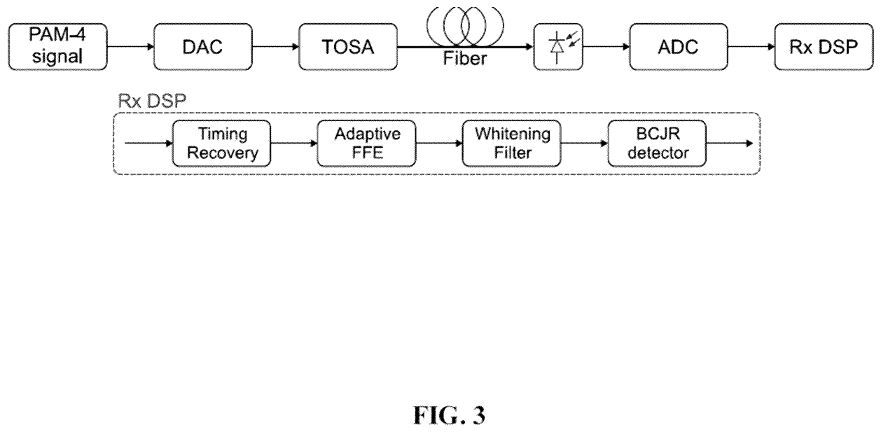

The present disclosure can be applied to any system and scenario, in which a soft-output MLSE detector is used in the receiver DSP. This can be an optical communication system as depicted in FIG. 3. In this system, a signal is transmitted over an optical fiber and the receiver DSP is used to evaluate the transmission. In this example, a PAM-4 signal is generated, digital-to-analog conversion (DAC) is performed and the electrical signal is modulated on an optical signal by a transmitter optical sub assembly (TOSA). The signal is transmitted over the optical fiber before it is received by a photodiode. After the following analog-to-digital conversion (ADC), the receiver DSP is conducted. The DSP can use different algorithms. In this embodiment, timing recovery is performed, then FFE is applied, before a noise whitening filter and BCJR detection are done.

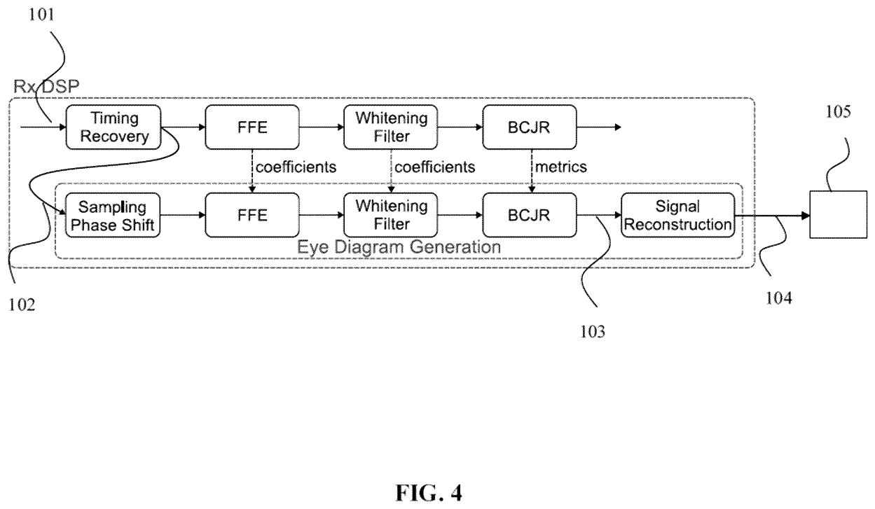

To generate an eye diagram after the BCJR detector, the proposed approach can be applied as depicted in FIG. 4. It should be noted that the BCJR detector is used as an example in this embodiment. The proposed approach also applies to other soft-output MLSE algorithms that can output LLRs. For instance, one of the following detectors: a SOVA detector, a BCJR detector, and a different realization of a MAP detector, may be used on the filtered signals to obtain the set of LLRs.

For the initialization, the timing recovery finds the optimal sampling phase and FFE coefficients, the noise whitening filter, and the BCJR metrics are converged based on the output signal. According to an embodiment of this disclosure, the apparatus 100 is configured to determine an optimal sampling phase for sampling the obtained digital signal 101.

Optionally, the apparatus 100 is further configured to obtain the one or more DSP parameters at the optimal sampling phase, wherein the DSP parameters comprise one or more of the following: an equalizing coefficient, a filtering coefficient, an MLSE transition metric, a threshold, and a normalization factor.

According to an embodiment of this disclosure, the apparatus 100 is configured to equalize the sampled digital signal 102 using the FFE based on one or more equalizing coefficients. The apparatus 100 is further configured to filter the equalized signal using the whitening filter based on one or more filtering coefficients, and apply the MLSE algorithm on the filtered signal based on one or more MLSE transition metrics.

That is, the collected DSP parameters are stored and re-used for the eye diagram generation procedure. For the eye diagram generation, the sampling phase of the ‘ideally’ sampled signal is shifted in a pre-defined range of sampling phases with a defined resolution.

According to an embodiment of this disclosure, the apparatus 100 is configured to sample the obtained digital signal 101 at the optimal sampling phase to obtain an optimal sampled digital signal. The apparatus 100 is further configured to determine a sampling phase shift, and
obtain the set of sampled digital signals based on the optimal sampled digital signal and the sampling phase shift using digital interpolation.

That is, the sampling phase shift can be realized by a digital interpolation if the signal at the input of the receiver DSP is available with sufficient oversampling. The digital interpolation can be realized in the frequency domain by multiplying the frequency domain representation of the oversampled signal with a phase term.

This can be expressed as:

$${y}_{s} = IFFT ( FFT ( y ) \cdot exp ( j 2 π f τ / ( N / 2 ) ) , \qquad ( 3 )$$

where y is the signal before the sampling phase shift, yₛ the phase shifted signal, FFT describes the fast Fourier transform, IFFT describes the inverse fast Fourier transform, f is the frequency vector, t is the sampling phase shift in unit intervals and N is the length of the signal.

As an alternative, an analog phase interpolator can be used to realize the desired sampling phase sweep. For each sampling phase under test, FFE, noise whitening filter, and BCJR detector are applied with the stored parameters. The resulting LLRs are used for the signal reconstruction and the reconstructed signal histogram is stored for each case.

According to an embodiment of this disclosure, the apparatus 100 is configured to phase shift the optimal sampling phase in a pre-defined range to obtain a set of sampling phases; and
sample the obtained digital signal 101 at each sampling phase of the set of sampling phases to obtain the set of sampled digital signals 102.

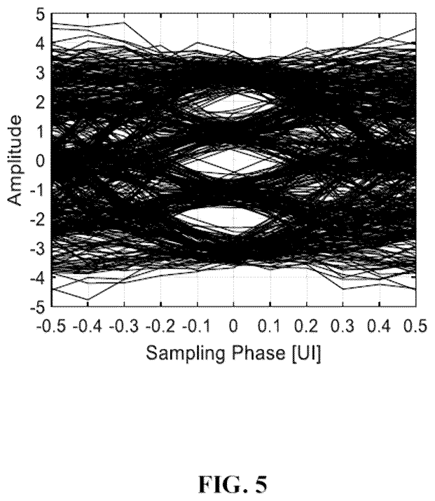

An example of an eye diagram for 112 GBd PAM-4 transmissions is shown in FIG. 5. Generally, the vertical eye-opening shows the signal quality at a certain sampling time. If the levels are clearly separated, the data can be recovered with few/no errors. If the levels are hardly distinguishable, reliable symbol decisions are not possible. The horizontal eye-opening gives insight into the tolerance towards sampling time/phase deviations. A wide horizontal opening means, that the performance penalty by inaccurate sampling is low.

The eye-opening of the eye diagram shown in FIG. 5 shows that the optimal sampling phase and small variations around it lead to a good performance, while strong deviations from this sampling phase significantly distort the performance.

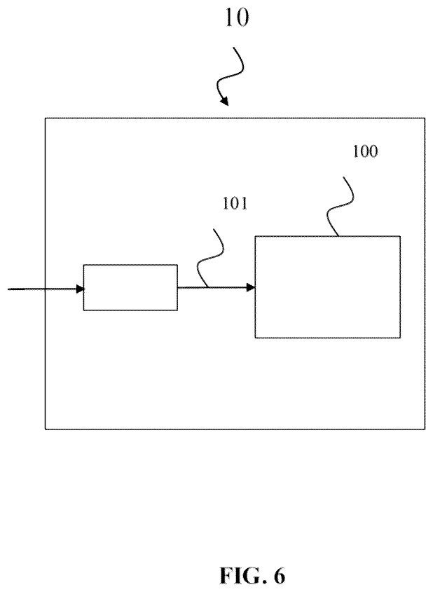

FIG. 6 shows a receiver device 10 according to this disclosure, which comprises the apparatus 10 shown in FIG. 1. Same elements are labeled with the same reference signs, and may function similarly or likewise.

The receiver device 10 may comprise a processor or processing circuitry (not shown) configured to perform, conduct, or initiate the various operations of the receiver device 10 described herein. The processing circuitry may comprise hardware and/or the processing circuitry may be controlled by software. The hardware may comprise analog circuitry digital circuitry, or both analog and digital circuitry. The digital circuitry may comprise components such as application-specific integrated circuits (ASICs), field-programmable arrays (FPGAs), digital signal processors (DSPs), or multi-purpose processors. The receiver device 10 may further comprise memory circuitry, which stores one or more instruction(s) that can be executed by the processor or by the processing circuitry, in particular under the control of the software. For instance, the memory circuitry may comprise a non-transitory storage medium storing executable software code which, when executed by the processor or the processing circuitry, causes the various operations of the receiver device 10 to be performed. In one embodiment, the processing circuitry comprises one or more processors and a non-transitory memory connected to the one or more processors. The non-transitory memory may carry executable program code which, when executed by the one or more processors, causes the receiver device 10 to perform, conduct, or initiate the operations or methods described herein.

In particular, the receiver device 10 is configured to receive a signal sent by a transmitter device over a channel and convert the signal into a digital signal 101. In this way, the apparatus 100 of the receiver device 10 is enabled to reconstruct the signal histograms after soft-output MLSE and generate eye diagrams after soft-output MLSE detectors based on reconstructed signal histograms.

The signal sent by the transmitter device is an optical signal, for example, a PAM signal. The receiver device 10 may comprise a photodetector to convert the optical signal into the electrical signal, e.g., the digital signal 101.

Notably, the receiver device 10 and solutions of this disclosure can be used in measurement equipment to characterize the quality of optical transmitters. The disclosure can support standardization and optical transmitter selection.

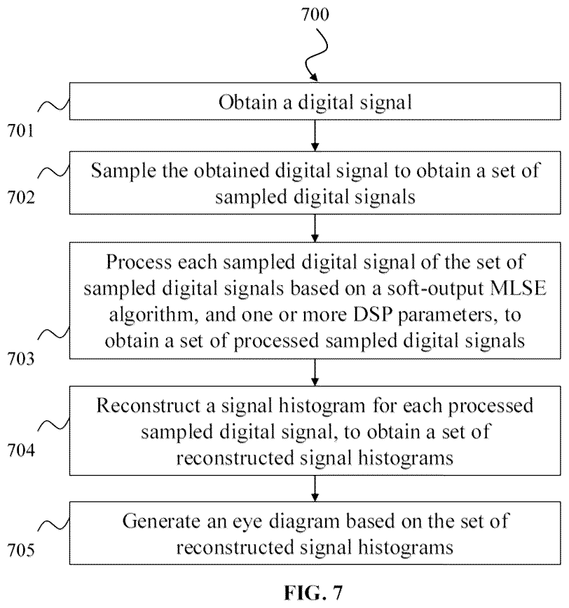

FIG. 7 shows a method 700 for generating an eye diagram of a digital signal at a receiver device according to this disclosure. The method 700 may be performed by the apparatus 100, as shown in FIG. 1 or FIG. 6.

The method 700 comprises a step 701 of obtaining the digital signal 101, wherein the digital signal 101 is based on a transmitting signal sent by a transmitter device over a channel to the receiver device. The method 700 further comprises a step 702 of sampling the obtained digital signal 101 to obtain a set of sampled digital signals 102; a step 703 of processing each sampled digital signal 102 of the set of sampled digital signals based on a soft-output MLSE algorithm and one or more DSP parameters, to obtain a set of processed sampled digital signals 103. The method 700 further comprises a step 704 of reconstructing a signal histogram 104 for each processed sampled digital signal 103, to obtain a set of reconstructed signal histograms 104; and a step 705 of generating an eye diagram 105 based on the set of reconstructed signal histograms 104.

To summarize, embodiments of the present disclosure enable the visualization of eye diagrams after soft-output MLSE and therefore allow more efficient prototyping and debugging in experimental setups. The solution provided in this disclosure brings the advantage, that the performance after MLSE (in a particular example, BCJR detection) can be directly estimated from the generated eye diagram. The generated eye diagram provides the correct performance not only for the optimal sampling phase but also for all sampling phases in the considered range.

The disclosure can provide value for the execution of transmission experiments. It is desirable to estimate the performance after the DSP schemes of interest. Therefore, the disclosure could be involved in instruments for the visualization of the received signal in the time domain, such as signal analyzers. While such instruments can already provide the options of showing the eye diagram of the received signal, also after DSP approaches like FFE, the extension to the capability of visualizing the MLSE eye diagram can bring benefits. These benefits lie in processes that need quick information about the transmission quality, such as prototyping and debugging of experimental setups.

The present disclosure has been described in conjunction with various embodiments as examples as well as implementations. However, other variations can be understood and effected by those persons skilled in the art and practicing the claimed matter, from the studies of the drawings, this disclosure, and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. An apparatus for generating an eye diagram of a digital signal at a receiver device, comprising:
processing circuitry configured to:
obtain the digital signal, wherein the digital signal is based on a transmitting signal sent by a transmitter device over a channel to the receiver device;
sample the obtained digital signal to obtain a set of sampled digital signals;
process each sampled digital signal of the set of sampled digital signals based on a soft-output maximum likelihood sequence estimation (MLSE) algorithm, and one or more digital signal processing (DSP) parameters, to obtain a set of processed sampled digital signals;
reconstruct a signal histogram for each processed sampled digital signal to obtain a set of reconstructed signal histograms; and
generate an eye diagram based on the set of reconstructed signal histograms.

2. The apparatus according to claim 1, the processing circuitry configured to process each sampled digital signal by:
equalizing the sampled digital signal using a feed forward equalizer (FFE);
filtering the equalized sampled digital signal using a whitening filter; and
applying the soft-output MLSE algorithm on the filtered signal output by the whitening filter, to obtain a processed sampled digital signal, wherein the processed sampled digital signal comprises a set of symbol-wise log-likelihood ratios (LLRs).

3. The apparatus according to claim 2, the processing circuitry configured to:
determine an optimal sampling phase for sampling the obtained digital signal.

4. The apparatus according to claim 3, the processing circuitry configured to:
sample the obtained digital signal at the optimal sampling phase to obtain an optimal sampled digital signal;
determine a sampling phase shift; and
obtain the set of sampled digital signals based on the optimal sampled digital signal and the sampling phase shift using digital interpolation.

5. The apparatus according to claim 3, the processing circuitry configured to:
phase shift the optimal sampling phase in a pre-defined range to obtain a set of sampling phases; and
sample the obtained digital signal at each sampling phase of the set of sampling phases to obtain the set of sampled digital signals.

6. The apparatus according to claim 3, the processing circuitry configured to:
obtain the one or more DSP parameters at the optimal sampling phase, wherein the DSP parameters comprise one or more of an equalizing coefficient, a filtering coefficient, an MLSE transition metric, a threshold, and a normalization factor.

7. The apparatus according to claim 6, the processing circuitry configured to:
equalize the sampled digital signal using the FFE based on one or more equalizing coefficients;
filter the equalized signal using the whitening filter based on one or more filtering coefficients; and
apply the MLSE algorithm on the filtered signal based on one or more MLSE transition metrics.

8. The apparatus according to claim 7, the processing circuitry configured to:
apply the MLSE algorithm on the filtered signal to obtain the set of LLRs using one of the following detectors:
a soft-output Viterbi (SOVA) detector,
a Bahl, Cocke, Jelinek and Raviv (BCJR) detector, and
a maximum a posteriori probability (MAP) detector.

9. The apparatus according to claim 8, the processing circuitry configured to determine a symbol level corresponding to each LLR.

10. The apparatus according to claim 9, the processing circuitry configured to
reconstruct the signal histogram for each processed sampled digital signal based on the set of LLRs and the symbol levels corresponding to the set of LLRs.

11. The apparatus according to claim 10, the processing circuitry configured to
obtain the normalization factor by analyzing the set of reconstructed signal histograms and the symbol levels corresponding to the set of LLRs.

12. The apparatus according to claim 6, the processing circuitry configured to
obtain the threshold by analyzing a histogram obtained after equalizing the obtained digital signal using FFE.

13. The apparatus according to claim 12, the processing circuitry configured to
generate the eye diagram by combining the set of reconstructed signal histograms based on the threshold and the normalization factor.

14. The apparatus according to claim 13, wherein the transmitting signal sent by the transmitter device is an optical signal.

15. A receiver device, comprising:
processing circuitry configured to:
obtain a digital signal, wherein the digital signal is based on a transmitting signal sent by a transmitter device over a channel to the receiver device;
sample the obtained digital signal to obtain a set of sampled digital signals;
process each sampled digital signal of the set of sampled digital signals, based on a soft-output maximum likelihood sequence estimation (MLSE) algorithm and one or more digital signal processing (DSP) parameters, to obtain a set of processed sampled digital signals;
reconstruct a signal histogram for each processed sampled digital signal to obtain a set of reconstructed signal histograms; and
generate an eye diagram based on the set of reconstructed signal histograms.

16. A method for generating an eye diagram of a digital signal at a receiver device, the method comprising:
obtaining the digital signal, wherein the digital signal is based on a transmitting signal sent by a transmitter device over a channel to the receiver device;
sampling the obtained digital signal to obtain a set of sampled digital signals;
processing each sampled digital signal of the set of sampled digital signals based on a soft-output maximum likelihood sequence estimation, MLSE, algorithm, and one or more digital signal processing, DSP, parameters, to obtain a set of processed sampled digital signals;
reconstructing a signal histogram for each processed sampled digital signal, to obtain a set of reconstructed signal histograms; and
generating an eye diagram based on the set of reconstructed signal histograms.
